(19) United States
(12) Patent Application Publication
(10) Pub. No.: US 2011/0215763 A1
(43) Pub. Date: Sep. 8, 2011

(54) SERIAL CHARGING AND DISCHARGING SYSTEM, AND METHOD OF DISCONNECTING CELL IN SERIAL CHARGING AND DISCHARGING SYSTEM

(75) Inventors: Yasuhiko SAWADA, Yokohama-shi (JP); Kenta Fukatsu, Fujisawa-shi (JP); Momoyo Sekiya, Yokohama-shi (JP); Yukihisa Hasegawa, Machida-shi (JP)

(73) Assignee: KABUSHIKI KAISHA TOSHIBA, Tokyo (JP)

(21) Appl. No.: 13/038,858

(22) Filed: Mar. 2, 2011

(30) Foreign Application Priority Data
Mar. 3, 2010 (JP) 2010-046566

(51) Int. Cl. H02J 7/00

(52) U.S. Cl. 320/134

(57) ABSTRACT

According to one embodiment, a serial charging and discharging system includes a cell connected in series to a power source for charging and discharging the cell, a diode provided upstream of the cell, a first switch connected in parallel to the diode, a second switch connected in series between the diode and the cell, a bypass circuit which bypasses the upstream of the diode and the downstream of the cell, a third switch connected to the bypass circuit; and a controller which controls the make and break of the first switch, the second switch, and the third switch.

### CROSS-REFERENCE TO RELATED APPLICATION

This application is based upon and claims the benefit of priority from Japanese Patent Application No. 2010-046566, filed on Mar. 3, 2010; the entire contents of which are incorporated herein by reference.

### FIELD

Embodiments described herein relate generally to a serial charging and discharging system which charges and discharges a cell, and a method of disconnecting a cell in a serial charging and discharging system.

### BACKGROUND

In a manufacturing process of a battery, there may be provided a process which charges and discharges a cell battery in the final process, depending on the type of battery. The charging and discharging process is provided in order to detect defects in the battery such as a short circuit by repeatedly charging and discharging the cell battery (simply referred to as “cell”, in the following).

There are a method of connecting a single power source to a single cell for charging and discharging the single cell (one-to-one method), and a method of connecting a single power source to a plurality of cells for charging and discharging the cells (serial method). Both methods have a merit and a demerit, and particularly, it is necessary to provide a circuit which measures the voltage of cells and disconnects a cell that has reached a predetermined voltage from the charging line, i.e., a so-called bypass circuit, because the cells are connected in series by the serial method.

### BRIEF DESCRIPTION OF THE DRAWINGS

FIG. 1 is a schematic diagram outlining a configuration of a serial charging and discharging system of an embodiment.

FIG. 2 is a circuit diagram illustrating a procedure of a method of disconnecting a cell in the serial charging and discharging system of the embodiment;

FIG. 3 is a timing chart illustrating the behavior of each switch in the serial charging and discharging system of the embodiment.

FIG. 4 is a circuit diagram illustrating a procedure of the method of disconnecting the cell in the serial charging and discharging system of the embodiment.

FIG. 5 is a circuit diagram illustrating a procedure of the method of disconnecting the cell in the serial charging and discharging system of the embodiment.

FIG. 6 is a circuit diagram illustrating a procedure of the method of disconnecting the cell in the serial charging and discharging system of the embodiment.

### DETAILED DESCRIPTION

In general, according one embodiment, a serial charging and discharging system includes a cell connected in series to a power source for charging and discharging the cell, a diode provided upstream of the cell, a first switch connected in parallel to the diode, a second switch connected in series between the diode and the cell, a bypass circuit which bypasses the upstream of the diode and the downstream of the cell, a third switch connected to the bypass circuit, and a controller which controls the make and break of the first switch, the second switch, and the third switch. With such a configuration, when performing an operation to disconnect the cell from a charging line, the serial charging and discharging system and a method of disconnecting the cell in the serial charging and discharging system, which can prevent the occurrence of a discharge state between the charging line and the bypass circuit, and can also reduce power loss as much as possible, can be provided.

Various Embodiments will be described hereinafter with reference to the accompanying drawings.

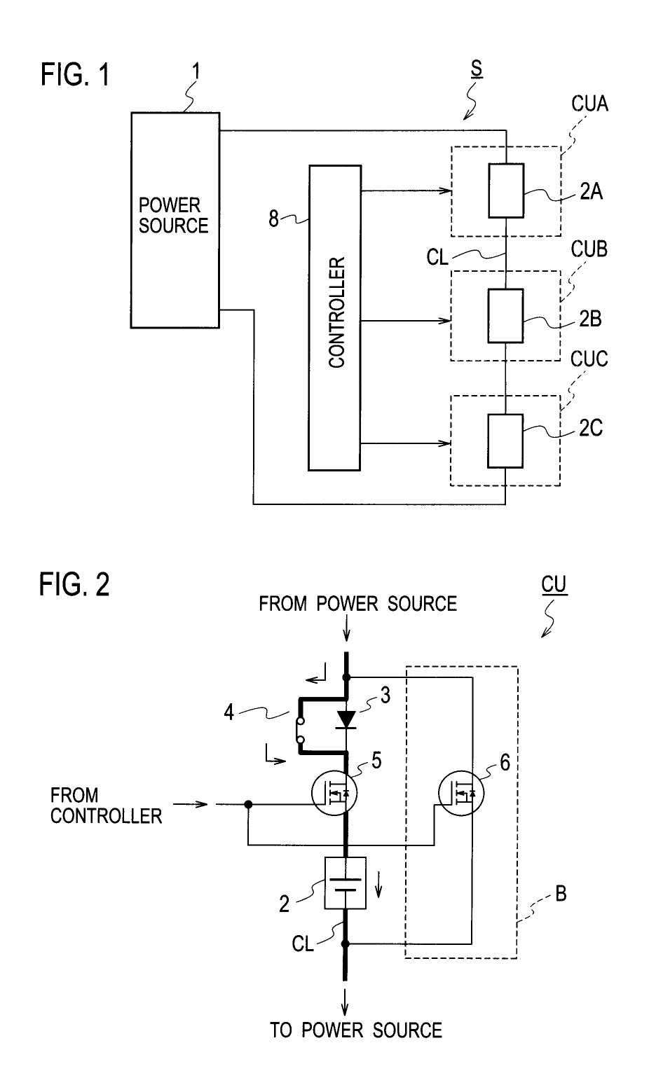

A serial charging and discharging system S of an embodiment has a plurality of cells 2 connected in series to a power source 1, as illustrated in FIG. 1. Although three cells 2A, 2B, and 2C are connected in FIG. 1, the number of cells 2 connected in series can be arbitrarily set. Meanwhile, in the following, the cells 2A, 2B, and 2C are collectively expressed as “cell 2” as appropriate.

The cell 2 is charged by being connected to the power source 1. Further., the cell 2 that has reached a predetermined voltage by charging needs to be disconnected from the serial charging and discharging system S (charging line) in order to avoid overcharge. Therefore, each cell 2 is provided with a bypass circuit and a mechanism for disconnected from the charging line. In FIG. 1, the cell 2, the bias circuit, and the mechanism are collectively expressed as a cell unit CU (cell units CUA, CUB, and CUC). In the following, however, the cell units CUA, CUB, and CUC are collectively expressed as a “cell unit CU” as appropriate.

FIG. 2 is a circuit diagram illustrating a procedure of a method of disconnecting a cell in the serial charging and discharging system S of the embodiment (the method of disconnecting a cell will be described below). FIG. 2 is also a circuit diagram illustrating a configuration of the cell unit CU in the serial charging and discharging system S of the embodiment. Here, the single cell unit CU is taken as an example to describe its configuration.

In the cell unit CU, the cell 2 is connected in series to the power source 1. Currents from the power source 1 flow in the direction of the solid-lined arrow illustrated in FIG. 2, whereby the cell 2 is charged. The line that charges the cell 2 is denoted as “charging line CL” for convenience.

A diode 3 is connected to the upstream of the cell 2 connected to the charging line CL. With each of the switches described below being turned ON or OFF, a closed loop may be formed between the charging line CL and the bypass circuit B. If such a situation arises, the diode 3 is connected to the upstream of the cell 2 on the charging line CL, in order to prevent discharge of the power which has been charged to the cell 2.

A first switch 4 is connected to the charging line CL so as to be in parallel with the diode 3. The first switch 4 is provided to avoid the occurrence of loss caused by the diode 3 on the charging line CL while the cell 2 is charged. Meanwhile, in the embodiment, a mechanical switch is employed as the first switch 4. Here, the mechanical switch is not a switching element such as FET, but is a switch that physically makes or breaks connection at a contact point.

The reason for employing the mechanical switch instead of the switching element as the first switch 4 is that the switching element includes a diode in its configuration. The diode included in the switching element is connected in such a manner that, when the switching element is appropriately connected to the charging line CL, current flows in the opposite direction of the charging. Therefore, if the switching element is employed as the first switch 4, a closed loop is formed between the charging line and the bypass circuit B described below, and thus the discharging of the cell 2 having been successfully charged is promoted. Accordingly, the mechanical switch is employed instead of the switching element as the first switch 4.

A second switch 5 is connected between the diode 3 and the cell 2 on the charging line CL. Although the second switch 5 is controlled to be constantly ON when the cell 2 is being charged, it is controlled to be turned OFF after charging of the cell 2 is finished to thereby prevent the overcharging of the cell 2.

The bypass circuit B is provided between an upstream of the diode 3 and a downstream of the cell 2. As described above, the cell 2 of the embodiment is connected in series to the power source 1. Accordingly, when the cell 2 that has been charged is disconnected from the charging line CL, it is essential so as not to interrupt charging of other cells 2 connected to the power source 1. Therefore, when the cell is disconnected from the charging line CL, the bypass circuit B is used in order to secure the charging line CL to cells connected downstream of the cell. In addition, the bypass circuit B plays the role of connecting the upstream of the diode 3 and the downstream of the cell 2 (see FIG. 2). Furthermore, a third switch 6 which controls power feeding of the bypass circuit B is connected along the bypass circuit B.

A control signal from a controller 8 is applied to the first switch 4 to control the make and break (ON and OFF) of the first switch 4. Meanwhile, in FIG. 2 (and FIGS. 4 to 6), a connection line to the controller 8 is omitted. In addition, the make and break of the second switch 5 and the third switch 6 is similarly controlled by the controller 8.

The controller 8 determines whether or not the cell reaches a predetermined voltage based on a value of a voltmeter (not illustrated) provided in the cell unit CU, for example, and controls the make and break of each switch so as to disconnect a cell determined to have reached the predetermined voltage. Specific control of each switch by the controller 8 will be described in the method of disconnecting the cell in the serial charging and discharging system S of the following embodiment.

The control signal to the second switch 5 and the third switch 6 is applied via a signal line from the controller 8, in the same as the case of the first switch 4 as illustrated in FIG. 2 (and FIGS. 4 to 6).

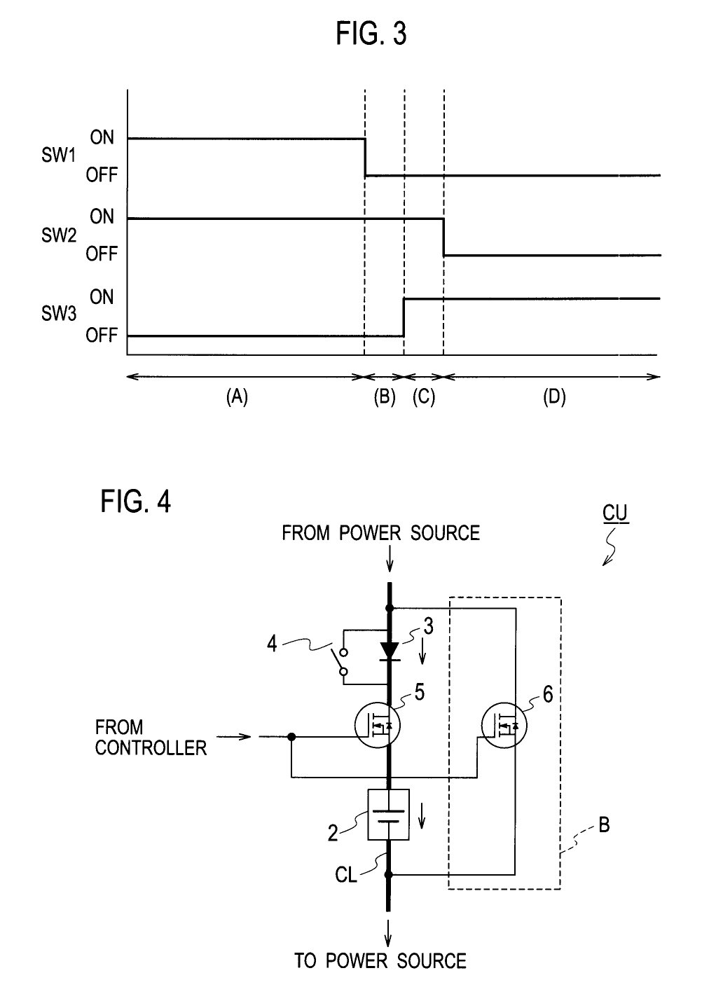

FIG. 3 is a timing chart illustrating the behavior of each switch of the embodiment. ,ON and OFF of the first switch 4 (denoted as “SW1 in FIG. 3), the second switch 5 (denoted as SW2 in FIG. 3), and the third switch 6 (denoted as SW3” in FIG. 3) are illustrated along a vertical axis of FIG. 3 from top to bottom. Furthermore, a horizontal axis of FIG. 3 represents time, indicating four divisional time zones A to D in FIG. 3 for convenience.

It should be noted that the width of each of the time zones A to D does not accurately represent the time required for the actual control, but is merely indicated roughly. However, the time zones B and C are both very short, with the time zones A and D being longer than the time zones B and C.

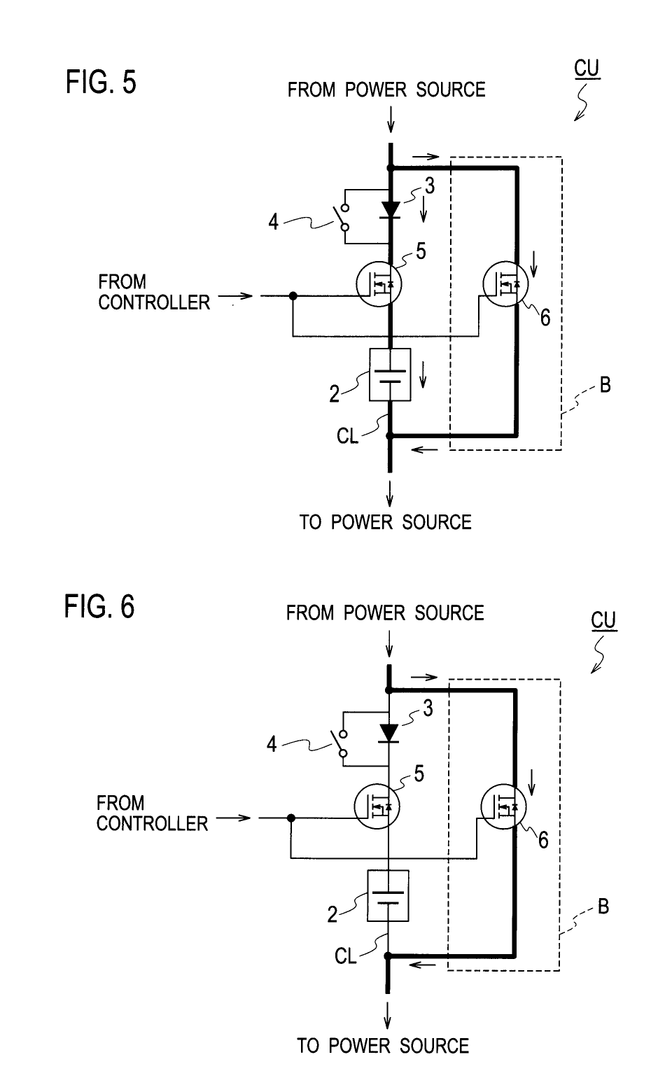

Next, the procedure of the method of disconnecting the cell in the serial charging and discharging system S of the embodiment will be described referring to FIG. 2 and FIGS. 4 to 6. The circuit diagram of FIG. 2 represents a circuit for the time zone A. In addition, the circuit diagram of FIG. 4 expresses a circuit for the time zone B, the circuit diagram of FIG. 5 expresses a circuit for the time zone C, and the circuit diagram of FIG. 6 expresses a circuit for the time zone D, respectively. Furthermore, in FIG. 2 and FIGS. 4 to 6, the line through which current from the power source 1 for charging the cell 2 flows is illustrated by a thick line, and the direction of the flow is illustrated by a solid arrow.

As described above, FIG. 2 illustrates a circuit for the time zone A. In this case, a state in which the cell 2 is being charged is illustrated. Therefore, the first switch 4 and the second switch 5 are turned ON, whereas the third switch 6 is turned OFF according to an instruction from the controller 8. The reason why the first switch 4 is turned ON is that the control of the first switch 4 so as to be OFF causes current to flow to the diode 3 connected in series to the charging line CL, whereby a loss by the diode 3 may take place. The loss by the diode 3 can also be avoided without interrupting the charging operation to each cell 2 connected in series to the power source 1 by turning ON the first switch 4 connected in parallel to the diode 3.

The reason why the second switch 5 is turned ON is that the charging line CL has to be energized in order to charge the cell 2. On the other hand, the bypass circuit B is not used because current from the power source 1 is in a state of being flowing through the charging line CL to thereby charge the cell 2. Accordingly, the third switch 6 is turned OFF.

The time zone B illustrated in FIG. 3 is a time zone where the voltage of the cell 2 has become approximately equal to the predetermined voltage after the charging operation, and FIG. 4 illustrates a state of each switch for this case. The time zone B is a time zone when a stage prior to the operation of disconnecting the cell 2 is carried out, which has been charged almost to the predetermined voltage. In the time zone B, the first switch 4 is turned OFF from ON in order to interrupt the supply of current from the power source 1 to the cell 2.

The reason why the first switch 4 is thus turned OFF in the time zone B is that the discharging of the cell 2 which has been charged to the predetermined voltage is prevented because a closed loop is formed by the charging line CL and the bypass circuit B if the first switch 4 remains ON when the third switch 6 is turned ON in the next time zone C. Therefore, the first switch 4 is turned OFF before turning ON the third switch 6 of the bypass circuit B, whereby the diode 3 prevents to cause current to flow in a direction opposite to the charge current flow when the third switch 6 is turned ON to thereby prevent discharging.

In addition, the second switch 5 remains ON in this state as well. This is because turning OFF even the second switch 5 in this time zone B may prevent the charging operation to other cells 2 connected to the downstream of the cell 2 to be disconnected, since the third switch 6 is still in a state of being OFF. Therefore, in order to continue the charging operation to the cells 2 which are not supposed to be disconnected, the second switch 5 is kept ON because a flow path of current from the power source 1 has to be secured.

The time zone C is a time zone when a phase subsequent to the operation of disconnecting the cell 2 which has been charged almost to the predetermined voltage. As illustrated in the timing chart of FIG. 3 and the circuit diagram of FIG. 5, the third switch 6 is turned ON with the first switch 4 in a state of OFF and the second switch 5 in a state of ON. This switch operation causes the current from the power source 1 to flow into both the charging line CL to which the second switch 5 is connected and the bypass circuit B to which the third switch 6 is connected.

As described above, if only the cell 2 to be disconnected is taken into account, it is possible to disconnect the cell 2 of interest from the charging line CL by turning OFF the second switch 5. However, this results in putting also the bypass circuit B into a state of being able to be powered with the charging line CL kept ON (the second switch 5 kept ON) in order to secure the supply of current to the cells which are connected downstream of the cell to be disconnected and which have not yet reached the predetermined voltage. Therefore, a control signal is transmitted from the controller 8 so that the third switch 6 connected to the bypass circuit B is turned ON.

The time zones B and C are very short time zones. Accordingly, employing a mechanical switch for the second switch 5 and the third switch 6, for example, may slow down their operation speed. Taking a long time to prepare for the disconnecting operation may cause a closed loop to be formed between the charging line CL and the bypass circuit B in relation with the first switch 4. In the embodiment, therefore, the occurrence of a discharged state of the cell 2 due to formation of a closed loop is prevented by employing the mechanical switch for the first switch 4 and employing a switching element having a high operation speed for the second switch 5 and the third switch 6.

The time zone D illustrated in FIG. 6 is a time zone when the disconnecting operation of the cell 2 after the charging operation has been completely finished and the current from the power source 1 flows into the bypass circuit B. FIG. 6 illustrates a state of each switch in this case. As illustrated in FIGS. 3 and 6, the first switch 4 and the second switch 5 are both turned OFF, with only the third switch 6 being ON. Such a control by the controller 8 causes the current from the power source 1 to flow into the bypass circuit B, and the cell 2 of this cell unit CU is disconnected from the power source 1. In addition, the charging operation to the cells connected downstream of the disconnected cell 2 is continued as in the past because the current from the power source 1 is supplied via the bypass circuit B.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A serial charging and discharging system, comprising:
a cell connected in series to a power source for charging and discharging the cell;
a diode provided upstream of the cell;
a first switch connected in parallel to the diode;
a second switch connected in series between the diode and the cell;
a bypass circuit which bypasses the upstream of the diode and the downstream of the cell;
a third switch connected to the bypass circuit; and
a controller which controls the make and break of the first switch, the second switch, and the third switch.

2. The serial charging and discharging system according to claim 1, wherein
the first switch is a mechanical switch, and the second switch and the third switch are switching elements.

3. A method of disconnecting a cell in a serial charging and discharging system, comprising the steps of:
charging a cell with a first switch and a second switch being turned ON, and a third switch being turned OFF;
turning OFF the first switch;
turning ON the third switch; and
disconnecting the cell from the step of charging with the second switch being turned OFF.

4. A serial charging and discharging system, comprising:
a cell connected in series to a power source for charging and discharging the cell;
a diode provided upstream of the cell;
a first switch connected in parallel to the diode;
a second switch connected in series between the diode and the cell;
a bypass circuit which bypasses the upstream of the diode and the downstream of the cell;
a third switch connected to the bypass circuit; and
a controller which controls the make and break of the first switch, the second switch, and the third switch, wherein
the controller controls respective switches so as to turn ON the first switch and the second switch, and turn OFF the third switch when charging the cell, and
the controller controls respective switches so as to turn OFF the first switch, subsequently turn ON the third switch, and then turn OFF the second switch when finishing the charging of the cell.

5. The serial charging and discharging system according to claim 4, wherein
the first switch is a mechanical switch, and the second switch and the third switch are switching elements.
